(19) United States
(12) Patent Application Publication
(10) Pub. No.: US 2019/0042557 A1
(43) Pub. Date: Feb. 7, 2019

(54) ONLINE FORUM ASSISTANCE

(71) Applicant: FUJITSU LIMITED, Kawasaki-shi (JP)

(72) Inventors: Yuko OKUBO, Berkeley, CA (US); Jorjeta G. JETCHEVA, San Jose, CA (US); Ajay CHANDER, San Francisco, CA (US)

(73) Assignee: FUJITSU LIMITED, Kawasaki-shi (JP)

(21) Appl. No.: 15/668,454

(22) Filed: Aug. 3, 2017

(51) Int. Cl. G06F 17/27; G06F 17/24; G06F 17/21; G06N 99/00

(52) U.S. Cl. CPC G06F 17/274; G06F 17/273; G06N 99/005; G06F 17/211; G06F 17/24

(57) ABSTRACT

A method of providing online forum assistance is provided, including receiving a post generated by a user and to be submitted in an online forum. The text of the post is analyzed via at least one processor. The online forum is analyzed via the at least one processor based on one or more machine learning models for the online forum. At least one user profile of at least one other user of the online forum is analyzed via the at least one processor based on the one or more machine learning models for the at least one user profile. At least one of one or more suggestions to the user and one or more modifications to the post are provided based on at least one of the analysis of the text of the post, the analysis of the online forum, and the analysis of the at least one user profile.

### FIELD

The embodiments discussed herein relate to online forum assistance.

### BACKGROUND

An online forum is an online discussion site where users may submit messages to share information and/or opinions on a particular topic.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include receiving a post generated by a user and to be submitted in an online forum. The method may also include analyzing, via at least one processor, text of the post. Further, the method may include analyzing, via the at least one processor, the online forum based on one or more machine learning models for the online forum. In addition, the method may include analyzing, via the at least one processor, at least one user profile of at least one other user of the online forum based on the one or more machine learning models for the at least one user profile. The method may also include providing at least one of one or more suggestions to the user and one or more modifications to the post based on at least one of the analysis of the text of the post, the analysis of the online forum, and the analysis of the at least one user profile.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts an example system that may be used to provide online forum assistance;

FIG. 2 shows an example flow diagram of a method of providing online forum assistance;

FIG. 3 depicts an example flow diagram of a method of receiving online forum assistance; and

FIG. 4 is a block diagram of an example computing system.

### DESCRIPTION OF EMBODIMENTS

The embodiments discussed herein, which may be applicable to online discussion forums, sites, platforms, and/or services, relate to improving the effectiveness of using online forums. For example, various embodiments of the present disclosure may enhance a user post to meet the user's needs, may improve audience targeting, initiate emotionally engaging interactions, and/or suggest questions to generate discussion.

Using online forums may present various problems and/or challenges (e.g., problems specifically arising in a particular computer realm). For example, an online forum post (also referred to herein as a “message”) may be ignored for various reasons. More specifically, posts and/or post topics may be misunderstood, users may fail to use the correct words and phrases to attract other participants (e.g., other users of the online forum), users may post the same message repetitively without knowing of previous posts and/or realizing what they are posting themselves is repetitive. Further, a user may not understand that posts may only be relevant for certain participants, and there may be limited or no opportunity for deepening the understanding of the content for other users.

Further, users may fail to achieve the desired engagement/discussion, due to, for example, failing to provide an emotionally engaging message, which may improve the effectiveness of communication, and/or failing to ask appropriate questions, which may facilitate dialogues. These and other issues may lead to missed opportunities to get to know others and/or find possible collaborators.

Various embodiments may provide technical solutions to the problems and/or issues disclosed above. For example, on online forum assistance system may improve the effectiveness of posting in online forums via providing users with tools and/or recommendations to help the users achieve their goals for their online posts, such as maximizing exposure (e.g., the number of people who read a post), receiving feedback, triggering active discussions, and/or increasing social interactions.

In some embodiments, machine learning techniques may be used to analyze the effectiveness of different types of posts in a specific online forum, and based thereon, an online forum assistance system may recommend updates and additions to a post (e.g. to better achieve a user's goals) including, for example, adjusting and/recommending a modification the language of a post, the sentiment of the post, the emotional style of the post (e.g., emotion of the user expressed in the post), the a length of the post, addition and/or modification of one or more associated keywords, the time of posting, and/or one or more suggested questions (e.g., to ask in the post and/or to be considered by the user before submitting the post to the online forum). Further, the online forum assistance system may assist users to more effectively engage with forum participants who comment on their posts, as well as those who post on related topics (e.g., via recommending actions in response to other users' posts).

More specifically, in some embodiments, a user may select one or more options (also referred to herein as “tags”) that best describe and/or define their current goals. Further, the user may be provided with information on previous posts submitted to the online forum that may related be related to the user's post (e.g., to avoid duplication). Further, the user may receive a suggestion for adding one or more options to their post that may help the user achieve their goals for the post. In some embodiments, based on analysis of prior activity of the online forum and analysis of user profiles (e.g., via machine learning), an online forum assistance system may suggest related keywords and topics that might attract forum participants' attention. Further, the online forum assistance system may suggest that the user express or suppress specific sentiments and emotions and/or suggest stylistic changes (e.g., more casual or more formal language). The online forum assistance system may also suggest “tagging” people who have expressed interest in similar posts/topics in the past, suggest a length for the post, and/or suggest a time of day to post. Accordingly, the user's post may be improved due to, for example, analyzing the user's post, prior activity on the online forum and/or user profiles (e.g., of the user and/or profiles of other users of the online forum).

In addition, the online forum assistance system may provide recommendations for initiating emotionally engaging interactions with other participants (e.g., friendly commenting (or clicking “like”) on posts of other users (e.g., that the user may want to read his/her posts)). Further, the online forum assistance system may suggest questions to add to a post to trigger discussion and/or questions to ask other users that the user wishes to engage with.

Thus, various embodiments disclosed herein are rooted in computer technology in order to overcome the problems and/or challenges described above. Further, various embodiments provide a specific technical solution to a technical problem. More specifically, for example, various embodiments provide a technology-based solution to provide online forum assistance to, for example, enhance communication, engagement (e.g., discussion, feedback, etc.), and help users achieve their goals. In additions, at least some embodiments herein may improve computer-related technology by allowing computer performance of a function not previously performable by a computer.

Embodiments of the present disclosure will be explained with reference to the accompanying drawings.

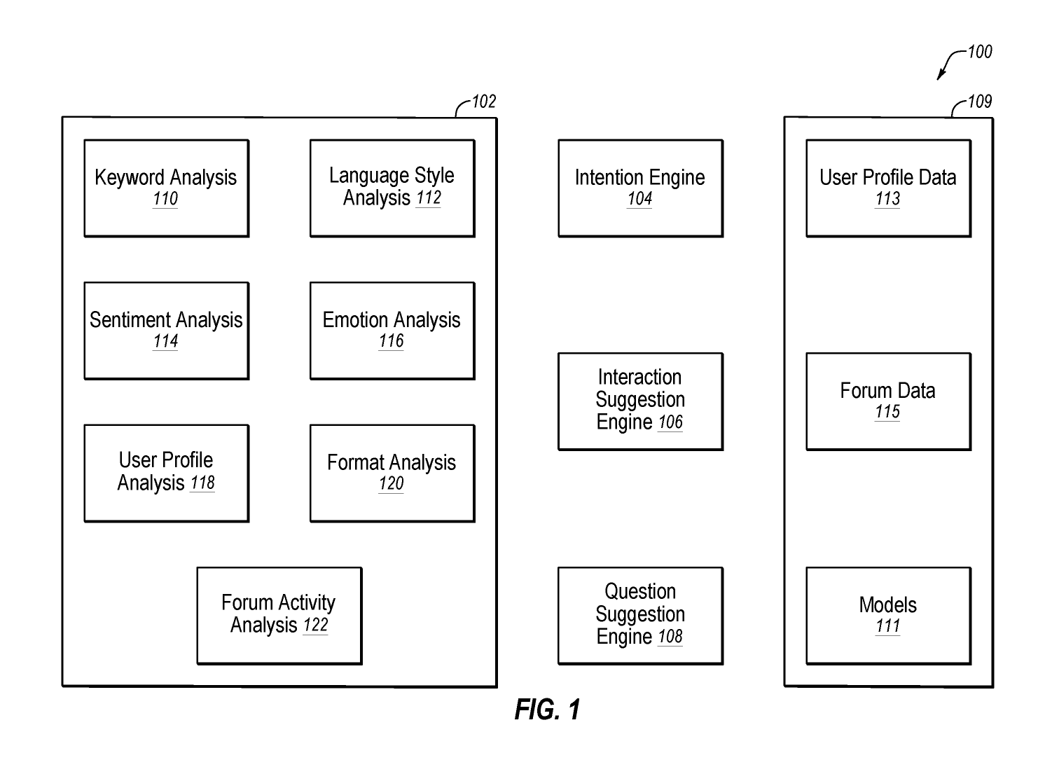

FIG. 1 depicts an example online forum assistance system 100, in accordance with at least one embodiment described herein. Online forum assistance system 100 includes an analysis engine 102, an intention engine 104, and interaction suggestion engine 106, a question suggestion engine 108, and a database 109.

Analysis engine 102 includes a plurality of modules for performing various analyses, such as analyses of a post, online forums, and/or users (also referred herein as “participants”) of online forums. Further, in some embodiments, intention engine 104 may be configured to suggest one or more options (“tags”) to be added to a post based on one or more analyses (e.g., message analysis, forum analysis, etc.). Interaction suggestion engine 106 may be configured to, for example, to notify a user to respond to a post or comment that may be relevant to the user's goals and/or suggest to the user proper sentiment, emotion, and/or style for a post to enhance emotional engagement of others. Question suggestion engine 108 may, according to some embodiments, suggest one or more questions for a user to ask in response to another post and/or comment from one or more others (e.g., to deepen a discussion with others).

With continued reference to FIG. 1, according to some embodiments, analysis engine 102 may include a keyword analysis module 110, a language style analysis module 112, a sentiment analysis module 114, an emotion analysis module 116, a user profile analysis module 118, a format analysis module 120, and an activity analysis module 122.

In some embodiments, a user may identify one or more goals when posting in an online forum. For example, a user may want their post to be read by others (e.g., to share information, to showcase expertise, etc.). To improve the likelihood of meeting this goal, online forum assistance system 100 may assist the user to, for example, post with clarity, post with appropriate style, identify the best audience for their post, use the appropriate format for the intended audience, post at an optimal time of day for intended audience, and/or avoid duplicate posts.

According to some embodiments, a user may draft a post, and prior to submitting the post to the online forum, the user may send the post to online forum assistance system 100. Further, online forum assistance system 100 may, based on one more analyses (e.g., of a specific online forum, the user, other users, and/or the post), provide one or more suggestions to the user and/or provide one or more modifications to the user's post.

According to various embodiments of the present disclosure, one or more of analysis engine 102, intention engine 104, interaction suggestion engine 106, and question suggestion engine 108 may have access to and/or may include one or more models (e.g., machine learning models) and/or one or more machine learning algorithms. Thus, one or more of analysis engine 102, intention engine 104, interaction suggestion engine 106, and question suggestion engine 108 may, in response to receipt of data (e.g., based on previous computations and/or analyses), adapt (e.g., learn) and generate reliable suggestions to a user and/or modification to a user's post.

For example only, keyword analysis module 110, which may include and/or have access to one or more models (e.g., machine learning models) and/or one or more machine learning algorithms, may be configured to update the one or more models based on prior analyses of content (e.g., one or more messages) within an online forum. Thus, keyword analysis module 110 may train itself as to what keywords may be effective in certain online forums. As another example, emotion analysis module 116, which may include and/or have access to one or more models (e.g., machine learning models) and/or one or more machine learning algorithms, may be configured to update its one or more models based on prior analyses of content (e.g., one or more messages) within an online forum. Thus, emotion analysis module 116 may train itself as to what emotions may be effective in certain online forums. As yet another example, question suggestion engine 108, which may include and/or have access to one or more models (e.g., machine learning models) and/or one or more machine learning algorithms, may be configured to update its one or more models based on prior analyses of content (e.g., one or more users, messages, etc.) of an online forum. Thus, emotion analysis module 116 may train itself as to what questions, asked to the user and/or by the user, may be effective in certain online forums.

Further, in some embodiments, database 109 may include one or more models 111 (e.g., machine learning models) and/or one or more machine learning algorithms associated with analysis engine 102, intention engine 104, interaction suggestion engine 106, and/or question suggestion engine 108. In addition, database 109 may include user profile data 113 (e.g., for one or more users of one or more online forums) and online forum data 115 (e.g., data related to one or more online forums), such as online forum logs, online forum posts, online forum statistics, or any other data associated with one or more online forums. In these and other embodiments, each engine and/or module of online forum assistance system 100 may be configured to access any needed data, such as other models 111, user profile data 113, and online forum data 115.

In one contemplated operation, in response to receipt of a post (e.g., at online forum assistance system 100), keyword analysis module 110 and/or activity analysis module 122 may analyze the post and recommend to a user to describe one or terms in a post in more detail (e.g., via detecting keywords unusual to a forum). Further, for example, language style analysis module 112 and/or activity analysis module 122 may recommend that a tone of a post be modified (e.g., to be more casual or more formal). More specifically, for example, one or more words within a post may be highlighted and one or more replacement words may be suggested (e.g., based on an accepted and/or typical forum style).

As another example, sentiment analysis module 114 and/or activity analysis module 122 may recommend that a sentiment of the post be modified (e.g., to be more positive, more negative, more neutral, etc.) based on, for example, an accepted and/or typical forum sentiment style. Further, for example, emotion analysis module 116 and/or activity analysis module 122 may recommend that the emotion of the post be modified (e.g., more passion, less or more anger, less or more sarcasm, etc.) based on, for example, an accepted and/or typical emotion for the forum.

In another example, based on, for example, the text of the post, forum participant profiles, and/or prior posts, user profile analysis module 118 and/or activity analysis module 122 may suggest to the user one or more others that may be interested in the post. More specifically, for example, user profile analysis module 118 and activity analysis module 122 may suggest one or more others to, for example, “tag” in the post. In addition, based on, for example, an optimal post format (e.g., a format of one or more posts that receive relatively high level of interest), sentiment analysis module 114 and/or activity analysis module 122 may suggest a post format (e.g., whether or not to include images and/or other formatting options) for the post.

As another example, based on, for example, an optimal post length (e.g., based on a length of posts that receive the most interest), format analysis module 120 and/or activity analysis module 122 may suggest a post length for the post. Moreover, for example, activity analysis module 122 may suggest a time of day to submit the post (e.g., based on posting times of one or more posts that tend to receive a relatively higher level of interest). In yet another example, activity analysis module 122 may identify related posts and/or discussions (e.g., submitted by the user or other users). Further, activity analysis module 122 may notify the user of a possible repetitive post.

As another example, a user may have one or more intentions, goals, and/or purposes for a post. To improve the likelihood of meeting these intentions, goals, and/or purposes, online forum assistance system 100 may assist the user to clarify the purpose of posting and/or attempt to trigger specific types of responses for each post.

More specifically, for example, in response to receipt of a post (e.g., at online forum assistance system 100), intention engine 104 may suggest one or more options for the post (e.g., to encourage and/or trigger discussion). Option types may include, for example, “topic,” “confidential,” “intention,” and “engagement.” Option examples may include “pilot service,” “internal only,” “get information,” and “find collaborator.”

More specifically, intention engine 104 may suggest that the user “tag” one or more others in the post and/or one or more other related posts. Further, intention engine 104 may suggest one or more questions, keywords and/or phases to be added to the post (e.g., “urgent,” “feedback needed,” “deadline,” “survey,” “looking for expert,” etc.) to clarify the post and/or trigger a desired response.

Further, a user may desire engagement (e.g., responses and/or discussion) with other users. To improve the likelihood of meeting this goal, online forum assistance system 100 may assist the user to socialize, learn (e.g., from other posts and/or from asking questions), and/or to collaborate with one or more others.

More specifically, for example, in response to receipt of a post at online forum assistance system 100, interaction suggestion engine 106 may alert a user to respond to a post and/or a comment that is relevant to the user's goals and/or suggest a sentiment, an emotion, and/or a style to use to achieve one or more goals (e.g., emotional engagement).

Further, as another example, question suggestion engine 108 may suggest one or more questions to ask in response to another post and/or comment (e.g., to deepen the discussion). Further, for example, question suggestion engine 108 may ask the user one or more questions regarding the user's post, the user's goals, the significance of the post, and/or other questions that may spur additional thought by the user.

In some embodiments, Bloom's Taxonomy, which is a known classification of learning objectives including three domains, may be used for suggesting questions to a user. More specifically, a cognitive domain of Bloom's Taxonomy includes six levels of objectives including level 1: knowledge (e.g., who, what, where); level 2: comprehension (e.g., understanding); level 3: application (e.g., apply information for interpretation); level 4: analysis (e.g., compare, contrast, distinguish, examine, etc.); level 5: synthesis (e.g., forming a whole from multiple parts); and level 6: evaluation (e.g., appraise, decide, judge, rate, etc.). The levels may be as guidance to suggest one or more questions to a user.

For example, question suggestion engine 108 may provide questions to the user such as “how do you compare your post with other similar post and/or topics?” (e.g., based on level 2 of Bloom's Taxonomy), “how is your post related with other posts?” (e.g., based on level 3 of Bloom's Taxonomy), “why is your post significant?” (e.g., based on level 3 of Bloom's Taxonomy), “how does your post compare and/or contrast with other posts?” (e.g., based on level 4 of Bloom's Taxonomy), “what evidence can you present for your post and/or other posts?” (e.g., based on level 4 of Bloom's Taxonomy), “what ideas can you add to your post?” (e.g., based on level 5 of Bloom's Taxonomy), “what might happen if you combined your post with other posts?” (e.g., based on level 5 of Bloom's Taxonomy), “what do you think about the topic of your post?” (e.g., based on level 6 of Bloom's Taxonomy), and/or “what is most important topic of your post?” (e.g., based on level 6 of Bloom's Taxonomy).

These and other questions may assist the user (e.g., cause the user) to determine whether others have posted on similar topics, to look at the topic of the user's post from a different perspective, to consider pros and cons of the topic of the user's post, to determine how to further develop the topic of the user's post, and/or how to synthesize the ideas in the post with other posts.

In yet another example, as noted above, activity analysis module 122 may identify one or more related posts and/or discussions, and notify the user of a possible repetitive post.

A more detailed description of a user's requirements (e.g., goals), and acts performed via online forum assistance system 100 in response thereto, will now be provided. For example, a user may wish to avoid bothering others, such as by sending repetitive posts. Thus, according to some embodiments, online forum assistance system 100 may access a log history of an online forum (e.g., scan all posts including time of posting, frequency of posting, time of visiting the forum, frequency of visiting the forum, etc.), identify tags of each post (e.g., scan tags of all posts indicating topic, user's sentiment toward the topic, a time of posts), and/or perform a sentiment analysis (e.g., determine whether the user is favorable, negative, or neutral to the topic posted).

Further, the user may wish to avoid sending a post to others who are likely uninterested. Thus, according to some embodiments, online forum assistance system 100 may access the log history, identify tags of each post, perform an emotion analysis (e.g., determine an emotion of the user from each post, suggest more effective words, grammar, and/or sentence structure), identify and access user profiles (e.g., via machine learning) (e.g., determine user profiles of the user's listing name, job title, company, project, interest, hobby, any other message, etc.).

In addition, the user may wish that others read the user's post. More specifically, the user may wish to post with clarity and style. Thus, online forum assistance system 100 may perform various operations on the text of the post including performing a spell check, a grammar check, a thesaurus/word check, etc. Further, the user may wish to reach a known target audience and/or an audience best suited for the post. Further, the user may wish the post is appropriate for the intended audience, such as a proper topic, proper formatting, proper timing, etc. Thus, according to some embodiments, online forum assistance system 100 may access the log history, identify tags of each post, identify and access user profiles, perform an emotion analysis, and/or provide one or more alerts to the user.

Moreover, the user may wish the post to be clearly understood. Thus, the user may wish to clarify the purpose of the post and/or trigger desired responses for the post. Thus, according to some embodiments, online forum assistance system 100 may suggest and/or add one or more tags to the post. For example, online forum assistance system 100 may suggest one or more tags that indicate preferences for each post, such as whether the user wants the post to be read by certain participants, determine expected responses, such as friendly responses, determine relevant information, identify experts, learn, and/or develop ideas.

In addition, the user may desire responses and/or engagement from/with others. For example, the user may wish to be acknowledged, may wish to socialize with others, and/or may wish to learn (e.g., from others). Thus, according to some embodiments, online forum assistance system 100 may suggest and/or add one or more tags to the user's post, suggest that the user acknowledge (“like”) other posts, suggest that the user send out encouraging and friendly comments after posting, and/or post questions to deepen ideas after posting.

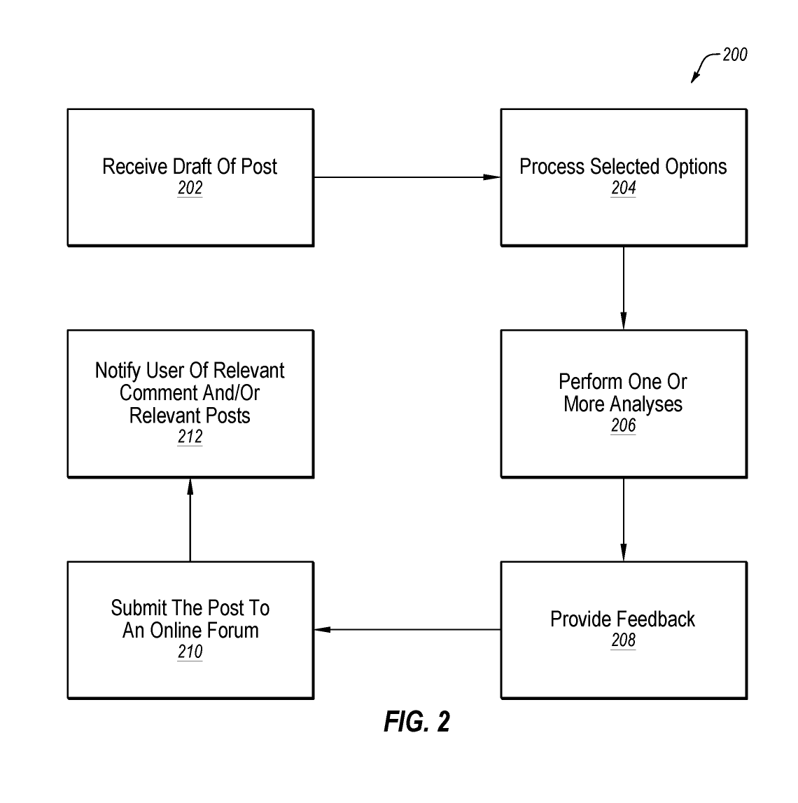

FIG. 2 shows an example flow diagram of a method 200 of providing online forum assistance, arranged in accordance with at least one embodiment described herein. Although illustrated as discrete blocks, various blocks may be divided into additional blocks, combined into fewer blocks, or eliminated, depending on the desired implementation.

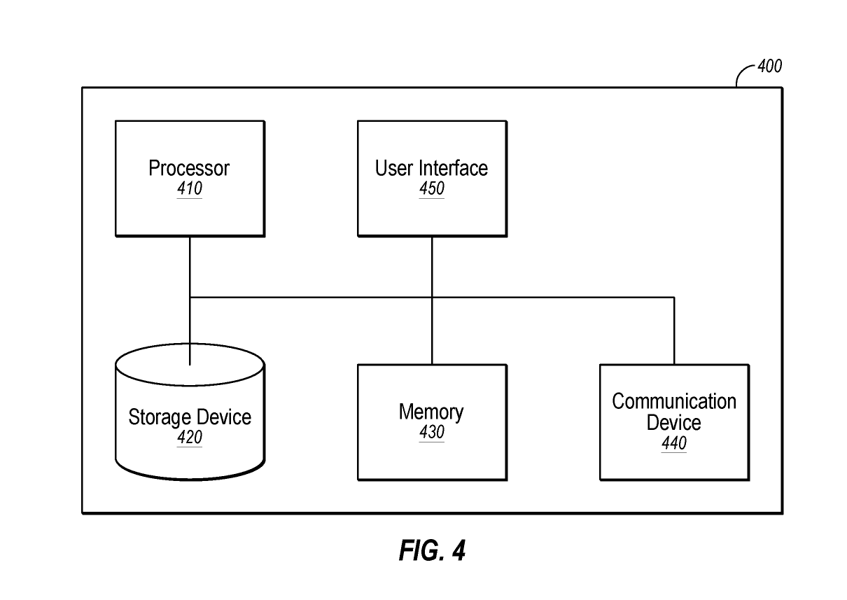

In some embodiments, method 200 may be performed by one or more devices and/or one or more systems, such system 100 of FIG. 1 and/or system 400 of FIG. 4. For instance, processor 410 of FIG. 4 may be configured to execute computer instructions stored on memory 430 to perform functions and operations as represented by one or more of the blocks of method 200.

Method 200 may begin at block 202. At block 202, a post, along with one or more user-defined (e.g., user-selected) options, may be received, and method 200 may proceed to block 204. For example, the post may be received at online forum assistance system 100 (see FIG. 1), which, in some embodiments, may include or be associated with system 400 (see FIG. 4). Further, the options may include one or more user-defined goals. In some embodiments, online forum assistance system 100 may utilize defaults options (e.g., if the user does not define one or more options).

At block 204, the one or more options for the post may be processed, and method 200 may proceed to block 206. For example, online forum assistance system 100 and/or processor 410 (see FIG. 4) may process the one or more options for the post. For example, online forum assistance system 100 may receive the options (e.g., user-defined or default options) and process the options to, for example, identify one or more analyses to be performed, as described below.

At block 206, one or more analyses may be performed on the post, the one or more selected options, an online forum to which the post may be submitted, the user (e.g., a user profile of the user), and/or one or more other users (e.g., via user profiles of others) of the online forum, and method 200 may proceed to block 208. For example, one or more modules of analysis engine 102 may analyze the post (e.g., the text (e.g., keywords), the sentiment, the emotion, language style, and/or format of the post) the one or more selected options, an online forum to which the post may be submitted, the user, and/or other users.

At block 208, feedback may be provided to the user, and method 200 may proceed to block 210. For example, in response to the one or more analyses performed at block 206, online forum assistance system 100 (e.g., analysis engine 102, intention engine 104, interaction engine 106, and/or question suggestion engine 108) may provide one or more suggestions (e.g., to edit the post, questions to ask, time to post, etc.) and/or modifications to the post.

At block 210, the post may be submitted to an online forum, and method 200 may proceed to block 212. In some embodiments, the post may be submitted to the online forum at a recommend time of day. In some embodiments, online forum assistance system 100 may be notified that the post has been submitted. In some embodiments, submission of the post may be independent of online forum assistance systems 100. In other embodiments, the post may be submitted to the online forum via online forum assistance system 100.

At block 212, the user may be notified of comments and/or other posts (e.g., by others), which may be relevant and/or in response to the user's submitted post. For example, online forum assistance system 100 may monitor activity of the online forum related to the user's post, and alert the user of any comments and/or posts related to the user's submitted post.

Modifications, additions, or omissions may be made to method 200 without departing from the scope of the present disclosure. For example, the operations of method 200 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

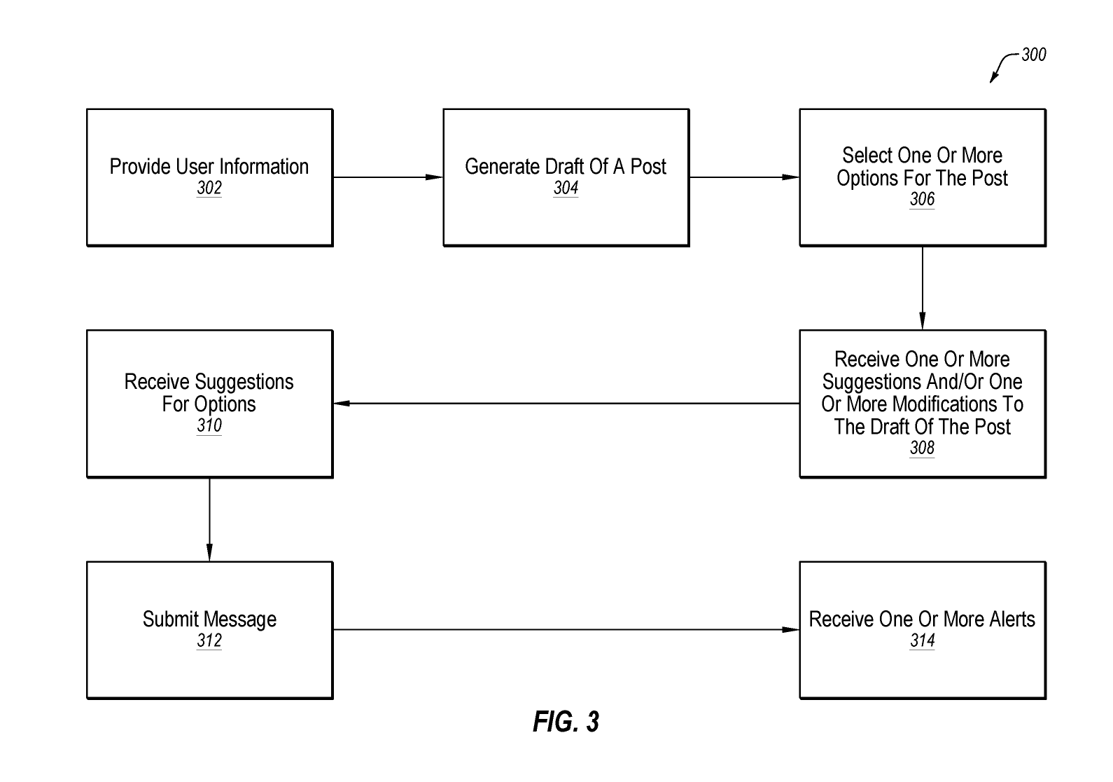

FIG. 3 shows an example flow diagram of a method 300 of receiving online forum assistance, arranged in accordance with at least one embodiment described herein. Although illustrated as discrete blocks, various blocks may be divided into additional blocks, combined into fewer blocks, or eliminated, depending on the desired implementation.

In some embodiments, method 300 may be performed by one or more devices and/or one or more systems, such as online forum assistance system 100 of FIG. 1 and/or system 400 of FIG. 4. For instance, processor 410 of FIG. 4 may be configured to execute computer instructions stored on memory 430 to perform functions and operations as represented by one or more of the blocks of method 300.

Method 300 may begin at block 302. At block 302, user information may be submitted, and method 300 may proceed to block 304. For example, the user information may be submitted to online forum assistance system 100 and/or system 400. In some embodiments, a user profile may be generated and/or updated via online forum assistance system 100 based on the provided user information.

At block 304, the user may draft a post for submission to an online forum, and method 300 may proceed to block 306. For example, the user may draft the post via a user interface (e.g., user interface 450 of FIG. 4) and a word processing application and/or text editor.

At block 306, the user may select one or more options for the post and the post may be submitted (e.g., to online forum assistance system 100), and method 306 may proceed to block 308. For example, the user, via a user interface (e.g., user interface 450 of FIG. 4), may select one or more options (e.g., goals), such as a “clarity” option, a “writing” option, and a “collaboration” option.

At block 308, the user may receive one or more suggestions for the post and/or a revised post including one or modifications, and method 300 may proceed to block 310. For example, online forum assistance system 100 may suggest more formal wording, more detail and/or additional explanation, and/or an optimal time to submit the post to the online forum. In some embodiments, online forum assistance system 100 may provide the user with a modified post (e.g., having modification to the text, format, tone, etc.). Further, online forum assistance system 100 may identify and notify the user of other posts and/or discussions on the online forum that may be relevant to the user's post.

At block 310, the user may receive one or more suggested options to be added to the post, and method 300 may proceed to block 312. For example, online forum assistance system 100 may provide the user with additional option suggestions. As non-limiting examples, a “request for feedback” and/or a “request for collaborators” may be suggested options to be added to the post. Further, for example, other related posts may be identified and suggested for being “tagged” by the user. In addition, other users that have posted about topics related to the user's post may be suggested as being “tagged” by the user.

At block 312, the user may submit the post to the online forum, and method 312 may proceed to block 314. For example, the user may submit the post via a user interface (e.g., user interface 450 of FIG. 4). In some embodiments, the user may submit the post independent of online forum assistance system 100. In other embodiments, the user may submit the post via online forum assistance system 100.

At block 314, the user may receive one or more alerts in response to relevant information related to the user's post submitted by one or more others. For example, online forum assistance system 100 may provide a notification (e.g., an alert and/or a recommendation) to the user to revisit the online forum to review the relevant information.

Modifications, additions, or omissions may be made to method 300 without departing from the scope of the present disclosure. For example, the operations of method 300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

Various contemplated example use cases will now be described. In one example, as user may generate a post which reads: “Hello, We will running a pilot study to examine how our work process can be made productive using tools. Please let us know your interest and thoughts.” Further, the user may select various “options” such as “reach out,” “target audience,” “pilot service,” “internal only,” and “writing.”

In response to receipt of the user's post and the selected options, online forum assistance system 100 may modify the post to read: “Hello, We will be offering a pilot service to find out how tools can help us become more productive at work. Please try out. Any feedback is appreciated.” Further, the online forum assistance system 100 may suggest additional options for the user to consider. For example, online forum assistance system 100 may suggest that the user edit the post to more clearly convey the intent of the post (e.g., feedback requested), a deadline for responding to the post, tags for related posts and/or tags for others who have previously posted about the topic.

After submission of the post to the online forum, one or more alerts may be provided to user in response to feedback (e.g., comments and/or other posts related to the user's post).

FIG. 4 is a block diagram of an example computing system 400, in accordance with at least one embodiment of the present disclosure. For example, system 100 (see FIG. 1), or one or more components thereof, may be implemented as computing system 400. Computing system 400 may include a desktop computer, a laptop computer, a server computer, a tablet computer, a mobile phone, a smartphone, a personal digital assistant (PDA), an e-reader device, a network switch, a network router, a network hub, other networking devices, or other suitable computing system.

Computing system 400 may include a processor 410, a storage device 420, a memory 430, a communication device 440, and user interface 450. Processor 410, storage device 420, memory 430, and/or communication device 440 may all be communicatively coupled such that each of the components may communicate with the other components. Computing system 400 may perform any of the operations described in the present disclosure.

In general, processor 410 may include any suitable special-purpose or general-purpose computer, computing entity, or processing device including various computer hardware or software modules and may be configured to execute instructions stored on any applicable computer-readable storage media. For example, processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, processor 410 may include any number of processors configured to perform, individually or collectively, any number of operations described in the present disclosure.

In some embodiments, processor 410 may interpret and/or execute program instructions and/or process data stored in storage device 420, memory 430, or storage device 420 and memory 430. In some embodiments, processor 410 may fetch program instructions from storage device 420 and load the program instructions in memory 430. After the program instructions are loaded into memory 430, processor 410 may execute the program instructions.

For example, in some embodiments one or more of the processing operations of a device and/or system (e.g., an application program, a server, etc.) may be included in data storage 420 as program instructions. Processor 410 may fetch the program instructions of one or more of the processing operations and may load the program instructions of the processing operations in memory 430. After the program instructions of the processing operations are loaded into memory 430, processor 410 may execute the program instructions such that computing system 400 may implement the operations associated with the processing operations as directed by the program instructions.

Storage device 420 and memory 430 may include computer-readable storage media for carrying or having computer-executable instructions or data structures stored thereon. Such computer-readable storage media may include any available media that may be accessed by a general-purpose or special-purpose computer, such as processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 410 to perform a certain operation or group of operations.

In some embodiments, storage device 420 and/or memory 430 may store data associated with online forum assistance. For example, storage device 420 and/or memory 430 may store models, machine learning algorithms, user profile data, posts, online forum data, or any data related to an online forum assistance system.

Communication device 440 may include any device, system, component, or collection of components configured to allow or facilitate communication between computing system 400 and another electronic device. For example, communication device 440 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication device 440 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to FIG. 4 without departing from the scope of the present disclosure. For example, computing system 400 may include more or fewer elements than those illustrated and described in the present disclosure. For example, computing system 400 may include an integrated display device such as a screen of a tablet or mobile phone or may include an external monitor, a projector, a television, or other suitable display device that may be separate from and communicatively coupled to computing system 400.

As used herein, the terms “module” or “component” may refer to specific hardware implementations configured to perform the operations of the module or component and/or software objects or software routines that may be stored on and/or executed by, for example, analysis engine 102, intention engine 104, interaction suggestion engine 106, and/or question suggestion engine 108. In some embodiments, the different components and modules described herein may be implemented as objects or processes that execute on a computing system (e.g., as separate threads). While some of the system and methods described herein are generally described as being implemented in software (stored on and/or executed by system 400), specific hardware implementations or a combination of software and specific hardware implementations are also possible and contemplated. In this description, a “computing entity” may include any computing system as defined herein, or any module or combination of modules running on a computing system, such as system 400.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
receiving a post generated by a user and to be submitted in an online forum;
analyzing, via at least one processor, text of the post;
analyzing, via the at least one processor, the online forum based on one or more machine learning models for the online forum;
analyzing, via the at least one processor, at least one user profile of at least one other user of the online forum based on one or more machine learning models for the at least one user profile; and
providing at least one of one or more suggestions to the user and one or more modifications to the post based on at least one of the analysis of the text of the post, the analysis of the online forum, and the analysis of the at least one user profile.

2. The method of claim 1, wherein providing comprises providing the one of one or more suggestions to the user including at least one of:
suggesting of a time of day to submit the post to the online forum;
suggesting a length of the post;
suggesting at least one question for the user to consider;
suggesting at least one question to ask in the post;
suggesting at least one question to ask in response to another post submitted to the online forum;
suggesting a modification to at least one of an emotion conveyed by the post, a sentiment conveyed by the post, and a tone of the post;
suggesting at least one goal-defining option to be added to the post; and
suggesting at least one other user to tag in the post.

3. The method of claim 1, further comprising analyzing, via the at least one processor, feedback from one or more users of the online forum in response to the post being submitted to the online forum.

4. The method of claim 1, further comprising updating at least one of the one or more machine learning models for the online forum and the one or more machine learning models for the at least one user profile based on additional content related to at least one of the online forum and the at least one user profile.

5. The method of claim 1, wherein providing comprises providing the one or more modifications to the post including at least one of:
modifying one or more words of the post;
adding one or more keywords to the post; and
modifying a format of the post.

6. The method of claim 1, wherein analyzing the text comprises at least one of:
performing a keyword analysis;
performing a language style analysis;
performing a sentiment analysis;
performing an emotion analysis; and
performing a format analysis.

7. The method of claim 1, further comprising receiving one or more user-defined options related to submission of the post to the online forum.

8. The method of claim 1, further comprising notifying the user of one or more responses by one or more others of the online forum related to the post.

9. The method of claim 1, further comprising analyzing, via the at least one processor, a user profile of the user based on one or more machine learning models for the user profile, wherein the providing at least one of one or more suggestions to the user and one or more modifications to the post is further based on the analysis of the user profile.

10. The method of claim 9, further comprising updating the one or more machine learning models for the user profile based on additional content submitted by the user.

11. A non-transitory computer-readable medium having computer instructions stored thereon that are executable by a processing device to perform or control performance of operations comprising:
receiving a post generated by a user and to be submitted in an online forum;
analyzing text of the post;
analyzing the online forum based on one or more machine learning models for the online forum;
analyzing at least one user profile of at least one other user of the online forum based on one or more machine learning models for the at least one user profile; and
providing at least one of one or more suggestions to the user and one or more modifications to the post based on at least one of the analysis of the text of the post, the analysis of the online forum, and the analysis of the at least one user profile.

12. The non-transitory computer-readable medium of claim 11, wherein providing comprises providing the one of one or more suggestions to the user including at least one of:
suggesting of a time of day to submit the post to the online forum;
suggesting a length of the post;
suggesting at least one question for the user to consider;
suggesting at least one question to ask in the post;
suggesting at least one question to ask in response to another post submitted to the online forum;
suggesting a modification to at least one of an emotion conveyed by the post, a sentiment conveyed by the post, and a tone of the post;
suggesting at least one goal-defining option to be added to the post; and
suggesting at least one other user to tag in the post.

13. The non-transitory computer-readable medium of claim 11, the operations further comprising analyzing feedback from one or more users of the online forum in response to the post being submitted to the online forum.

14. The non-transitory computer-readable medium of claim 11, the operations further comprising updating at least one of the one or more machine learning models for the online forum and the one or more machine learning models for the at least one user profile.

15. The non-transitory computer-readable medium of claim 11, wherein providing comprises providing the one or more modifications to the post including at least one of:
modifying one or more words of the post;
adding one or more keywords to the post; and
modifying a format of the post.

16. The non-transitory computer-readable medium of claim 11, wherein analyzing the text comprises at least one of:
performing a keyword analysis;
performing a language style analysis;
performing a sentiment analysis;
performing an emotion analysis; and
performing a format analysis.

17. The non-transitory computer-readable medium of claim 11, the operations further comprising receiving one or more user-defined options related to submission of the post to the online forum.

18. The non-transitory computer-readable medium of claim 11, the operations further comprising notifying the user of one or more responses by one or more others of the online forum related to the post.

19. The non-transitory computer-readable medium of claim 11, the operations further comprising analyzing a user profile of the user based on one or more machine learning models for the user profile, wherein the providing at least one of one or more suggestions to the user and one or more modifications to the post is further based on the analysis of the user profile.

20. The non-transitory computer-readable medium of claim 19, the operations further comprising updating the one or more machine learning models for the user profile based on additional content submitted by the user.
